(19) United States
(12) Patent Application Publication
(10) Pub. No.: US 2013/0284701 A1
(43) Pub. Date: Oct. 31, 2013

(54) METHOD OF MANUFACTURING DIELECTRIC DEVICE AND ASHING METHOD

(71) Applicants: Yoshiaki Yoshida, Shizuoka (JP); Yutaka Kokaze, Shizuoka (JP)

(72) Inventors: Yoshiaki Yoshida, Shizuoka (JP); Yutaka Kokaze, Shizuoka (JP)

(73) Assignee: ULVAC, INC., Kanagawa (JP)

(21) Appl. No.: 13/995,846

(22) PCT Filed: Dec. 19, 2011
(86) PCT No.: PCT/JP2011/007066

§ 371 Date: Jun. 19, 2013

(30) Foreign Application Priority Data
Dec. 20, 2010 (JP) 2010-282603

(51) Int. Cl. H01B 19/04

(52) U.S. Cl. CPC H01B 19/04
USPC 216/64; 216/67

(57) ABSTRACT

[Object] To provide a method of manufacturing a dielectric device and an ashing method that are capable of suppressing the occurrence of resist residue.

[Solving Means] In the ashing method, a base material having a surface etched by a plasma of chlorine gas or fluorocarbon gas via a resist mask (6) formed of an organic material is disposed in a chamber, bombardment treatment is performed on the resist mask (6) by using oxygen ions in the chamber, and the resist mask is removed by using oxygen radicals in the chamber. According to the ashing method described above, etching reactants adhering to the surface of the resist mask are physically removed by the bombardment treatment using oxygen ions. Thus, it is possible to suppress the occurrence of resist residue due to the etching reactants and efficiently remove the resist mask from the surface of the base material.

### TECHNICAL FIELD

The present invention relates to a method of manufacturing a dielectric device, including a process of removing a resist mask used in etching, and to an ashing method for a resist mask.

### BACKGROUND ART

In recent years, dielectric devices such as a piezoelectric element and a memory element each have the structure in which a dielectric layer is sandwiched by a pair of electrode layers, in this type of dielectric device, an upper electrode layer and the dielectric layer are etched to have a predetermined shape so that this type of dielectric device is used as a piezoelectric device, a memory cell, and the like. Dry etching using an organic resist is widely used as the etching of the upper electrode layer and the dielectric layer. Chlorine gas or chlorofluorocarbon gas is used as etching gas, and an oxygen plasma is widely used to remove a resist mask after etching (see, for example, Patent Document 1 below).

Patent Document 1: Japanese Patent Application Laid-open No. 2009-206329 (paragraph [0042])

### DISCLOSURE OF THE INVENTION

### Problem to be Solved by the Invention

However, the etching in which chlorine gas or chlorofluorocarbon gas is used has a problem that resist residue is liable to occur at a time of subsequent ashing treatment of a resist mask by an oxygen plasma. It has been confirmed that the resist residue is a matter generated when a reactant of etching gas, which is generated at a time of etching of the upper electrode layer or dielectric layer, adheres to the surface of the resist mask. The resist residue influences device characteristics. For example, as to a resistance random access memory element (ReRAM), desired electrical characteristics cannot be stably obtained due to the resist residue.

In view of the circumstances as described above, it is an object of the present invention to provide a method of manufacturing a dielectric device and an ashing method that are capable of suppressing the generation of resist residue.

### Means for Solving the Problem

To achieve the object described above, according to an embodiment of the present invention, there is provided a method of manufacturing a dielectric device, including producing a laminated body in which a first electrode, a dielectric layer, and a second electrode layer are sequentially formed on a base material.

On the second electrode layer, a resist mask formed of an organic material is formed.

The second electrode layer and the dielectric layer are sequentially etched by a plasma of chlorine gas or fluorocarbon gas via the resist mask.

Bombardment treatment is performed on the resist mask by using oxygen ions.

The resist mask is removed by using oxygen radicals.

Further, according to another embodiment of the present invention, there is provided an ashing method including disposing a base material in a chamber, the base material having a surface etched by a plasma of chlorine gas or fluorocarbon gas via a resist mask formed of an organic material.

Bombardment treatment is performed on the resist mask by using oxygen ions in the chamber.

The resist mask is removed by using oxygen radicals in the chamber.

### BRIEF DESCRIPTION OF DRAWINGS

FIG. 1 are schematic process diagrams for describing a method of manufacturing a dielectric device according to an embodiment of the present invention,

FIG. 2 is a schematic diagram of a dry etching apparatus used in the embodiment of the present invention.

FIG. 3 is a schematic diagram of an ashing apparatus used in the embodiment of the present invention.

FIG. 4 are schematic process diagrams for describing an ashing method according to the embodiment of the present invention.

### MODE(S) FOR CARRYING OUT THE INVENTION

According to an embodiment of the present invention, there is provided a method of manufacturing a dielectric device, including producing a laminated body in which a first electrode, a dielectric layer, and a second electrode layer are sequentially formed on a base material.

On the second electrode layer, a resist mask formed of an organic material is formed.

The second electrode layer and the dielectric layer are sequentially etched by a plasma of chlorine gas or fluorocarbon gas via the resist mask.

Bombardment treatment is performed on the resist mask by using oxygen ions.

The resist mask is removed by using oxygen radicals.

In the method of manufacturing a dielectric device, etching reactants adhering to the surface of the resist mask are physically removed by the bombardment treatment using the oxygen ions. Thus, the occurrence of resist residue due to the etching reactants is suppressed, and the resist mask is efficiently removed from the surface of the base material. Therefore, according to the method described above, a dielectric device having desired characteristics can be stably manufactured.

For the chlorine gas, gas containing BCl₃ is used, for example. For the fluorocarbon gas, gas containing any one of CF₄, C₃F₈, C₄F₈, and CHF₃ is used, for example.

The performing bombardment treatment on the resist mask includes introducing oxygen into the chamber and applying high frequency bias power to the base material. The high frequency bias power causes generation of an oxygen plasma in a chamber and further causes ions in the plasma to be drawn to the surface of the base material. Thus, etching reactants on the surface of the resist mask are removed by a sputtering action of ions.

The removing the resist mask includes exposing the base material to oxygen radicals in an electrically non-biased state, the oxygen radicals being introduced into the chamber. By contact of the oxygen radicals and the resist mask, the resist mask is subjected to ashing. At that time, since the base material is in the electrically non-biased state, the base material does not undergo the sputtering action of ions. Therefore, the etching of the first electrode layer serving as a base is prevented.

The dielectric layer is appropriately selected in accordance with the type of dielectric device. For example, in the case where the dielectric device is a resistance random access memory element, for example, transition metal oxides such as CoO, NiO, CuO, Cu₂O, TiO₂, ZnO, Al₂O₃, LNO, Y₂O₅, SrZrO₇, and Ta₂O₅ are used as the dielectric layer.

Additionally, in the case where the dielectric device is a piezoelectric element, the dielectric layer may be, for example, ferroelectrics such as lead zirconate titanate (PZT: Pb(Zr,Ti)O₃), bismuth titanate (BTO: Bi₄Ti₃O₁₂), bismuth lanthanum titanate (BLT: (Bi,La)₄Ti₃O₁₂), and lanthanum-doped lead zirconate titanate (PLZT: (PbLa)(ZrTi)O₃).

According to another embodiment of the present invention, there is provided an ashing method including disposing a base material in a chamber, the base material having a surface etched by a plasma of chlorine gas or fluorocarbon gas via a resist mask formed of an organic material.

Bombardment treatment is performed on the resist mask by using oxygen ions in the chamber.

The resist mask is removed by using oxygen radicals in the chamber.

In the ashing method described above, etching reactants adhering to the surface of the resist mask are physically removed by the bombardment treatment using oxygen ions. Thus, it is possible to suppress the occurrence of resist residue due to the etching reactants and efficiently remove the resist mask from the surface of the base material.

Hereinafter, an embodiment of the present invention will be described with reference to the drawings.

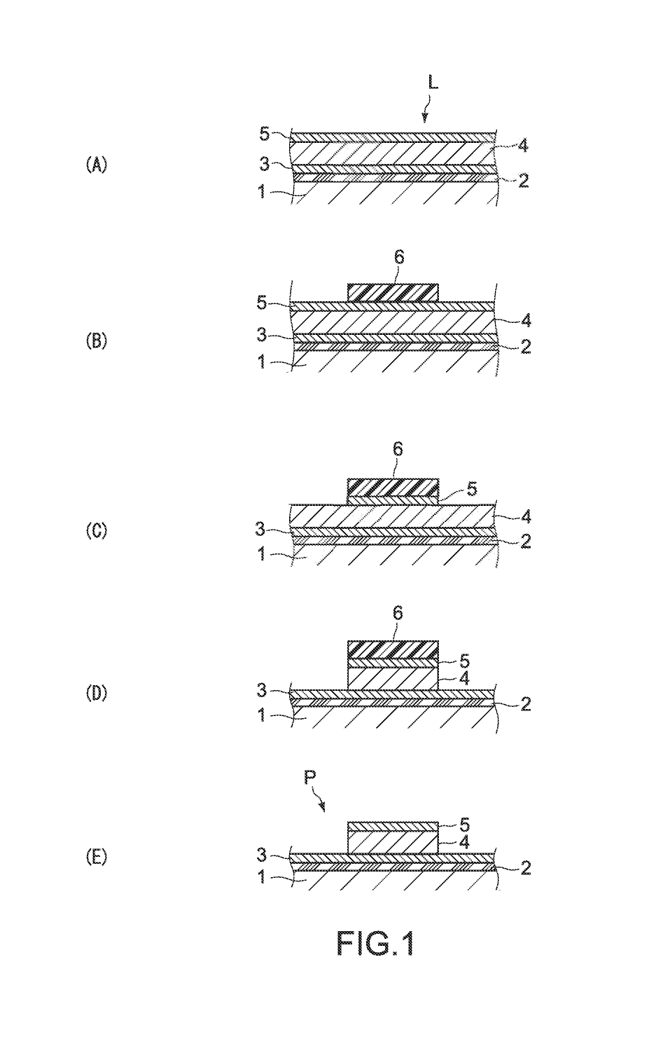

FIG. 1 are schematic process diagrams for describing a method of manufacturing a dielectric device according to an embodiment of the present invention. In this embodiment, a resistance random access memory element having the structure in which a transition metal oxide layer is sandwiched by a pair of electrodes will be exemplified as a dielectric device.

Here, the resistance random access memory element refers to a memory element capable of recoding and reading out information by electrically controlling a resistive state of a dielectric layer. in this type of memory element, a lower electrode formed of a conductive substance, a dielectric layer formed of a transition metal oxide, and an upper electrode formed of a conductive substance are laminated in this order. Additionally, for example, with the upper electrode being used as a positive electrode and the lower electrode being used as a negative electrode, when a pulsed positive voltage is applied between both the electrodes, the dielectric layer is put into a low resistive state, and when a pulsed negative voltage is applied between both the electrodes, the dielectric layer is put into a high resistive state. Thus, information is recorded. Further, a sense current is caused to flow in a thickness direction of the dielectric layer, and then a resistance value is measured to distinguish between the high resistive state and the low resistive state, thus reading out the recorded information.

[Production Process of Laminated Body]

FIG. 1(A) shows a production process of a laminated body. In this process, a laminated body L having a laminated structure including an insulating layer 2, a lower electrode layer 3 (first electrode layer), a dielectric layer 4, and an upper electrode layer 5 (second electrode layer) on a substrate 1 (base material) is produced. The substrate 1 may be a glass substrate or a semiconductor substrate such as a silicon substrate.

The insulating layer 2 is formed of SiO₂, for example.

The lower electrode layer 3 is formed of a metal material such as Pt (platinum), Ir (iridium), Ta (tantalum), Ti (titanium), TiN (titanium nitride), Al (aluminum), and W (tungsten). The lower electrode layer 3 is formed on the substrate 1 by a thin-film forming method such as a sputtering method, a vacuum vapor deposition method, and a CVD method. The thickness of the lower electrode layer 3 is not particularly limited and is 0.005 to 0.100 μm, for example.

The dielectric layer 4 is formed of a transition metal oxide layer. As a transition metal oxide, for example, CoO, NiO, CuO, Cu₂O, TiO₂, ZnO, Al₂O₃, LNO, Y₂O₅, SrZrO₂, Ta₂O₅, and the like are used. The dielectric layer 4 is formed on the lower electrode layer 3 by a thin-film. forming method such as a sputtering method, a CVD method, and a soft-gel method. The thickness of the dielectric layer 4 is not particularly limited and is 0.003 to 0.100 μm, for example.

The upper electrode layer 5 is formed of a metal material such as Pt, Ir, Ta, Ti, TiN, Al, and W. The upper electrode layer 5 is formed on the dielectric layer 4 by a thin-film forming method such as a sputtering method, a vacuum vapor deposition method, and a CVD method. The thickness of the upper electrode layer 5 is not particularly limited and is 0.005 to 0.100 μm, for example.

[Etching Process of Upper Electrode Layer]

FIGS. 1(B) and 1(C) show an etching process of the upper electrode layer 5. As shown in FIG. 1(B), a resist mask 6 having a predetermined shape is formed on the upper electrode layer 5. The resist mask 6 is patterned into a predetermined shape through processes of application of a photosensitive organic photoresist (PR), exposure, development, and the like. The photoresist may be a dry film resist. The thickness of the resist mask 6 is not particularly limited and is 0.5 to 10 μm, for example,

Next, as shown in FIG. 1(C), the upper electrode layer 5 is etched via the resist mask 6. The etching method for the upper electrode layer 5 may be a dry etching method or a wet etching method. In this embodiment, a dry etching method is adopted, and chlorine gas (for example, mixed gas of Cl₂ and BCl₃) is used as etching gas.

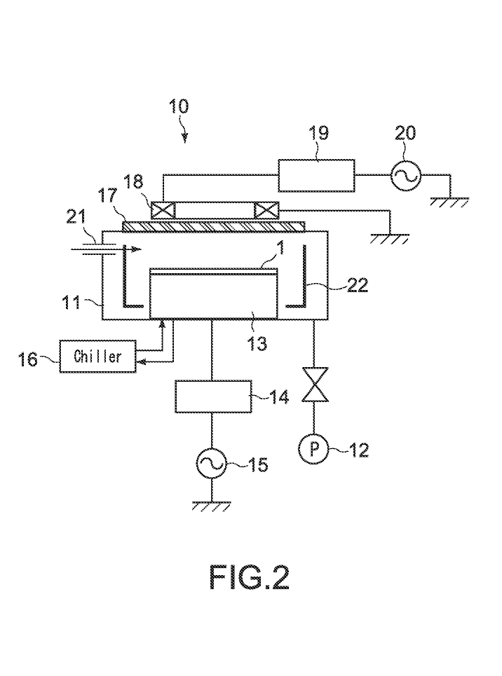

In the etching process of the upper electrode layer 5, a dry etching apparatus having a configuration as shown in FIG. 2 is used.

A dry etching apparatus 10 includes a vacuum chamber 11. The vacuum chamber 11 is connected to a vacuum pump 12 and can keep a predetermined reduced-pressure atmosphere in the inside thereof Inside the vacuum chamber 11, a stage 13 for supporting the substrate 1 on which the laminated body L is formed is provided. The stage 13 is connected to a high frequency power supply 15 having a frequency of 400 kHz via a matching circuit 14, and predetermined bias power can be input to the stage 13. The stage 13 is further connected to a chiller 16, and the substrate 1 on the stage 13 can be cooled to a predetermined temperature by cooled He gas.

A top surface portion of the vacuum chamber 11, which is opposed to the upper surface of the stage 13, is covered with a window 17 formed of a dielectric material such as quartz. Immediately above the window 17, an antenna coil 18 is provided. The antenna coil 18 is supplied with power from a high frequency power supply 20 having a frequency of 13.56 MHz via a matching circuit 19 and generates a plasma of etching gas introduced into the vacuum chamber 11 via a gas introduction line 21. Thus, the surface of the substrate 1 on the stage 13 is etched. An adhesion preventing plate 22 for preventing etching reactants from adhering to an inner wall surface of the vacuum chamber 11 is provided around the stage 13.

For the etching of the upper electrode layer 5, mixed gas of Cl₂ and BCl₃ is used. Etching conditions are not particularly limited. For example, a pressure is 0.5 Pa, a gas introduction amount is 40 sccm of Cl₂ and 10 sccm of BCl₃, antenna power (power supplied to the antenna coil 18) is 800 W, bias power (power supplied to the stage 13) is 150 W, a chiller temperature (substrate temperature) is 20° C., and an etching time is 40 seconds.

[Etching Process of Dielectric Layer]

After the etching process of the upper electrode layer 5 is finished, a process of etching the dielectric layer 4 to expose the lower electrode layer 3 is performed. FIG. 1(D) shows an etching process of the dielectric layer 4.

In this process, the resist mask 6 used as the etching mask for the upper electrode layer 5 may be used as an etching mask for the dielectric layer 4, or a resist mask separately formed may be used.

In the etching process of the dielectric layer 4, for example, the dry etching apparatus 10 shown in FIG. 2 is used. In etching of the dielectric layer 4, chlorine gas is used as etching gas. In this embodiment, mixed gas of Ar and BCl₃ is used. Etching conditions are not particularly limited. For example, a pressure is 0.5 Pa, a gas introduction amount is 40 sccm of Ar and 10 sccm of BCl₃, antenna power is 800 W, bias power is 150 W, a chiller temperature (substrate temperature) is 20° C., and an etching time is 40 seconds.

[Removal Process of Resist Mask]

Next, as shown in FIG. 1(E), the resist mask 6 is removed by ashing. Thus, a dielectric device P is manufactured.

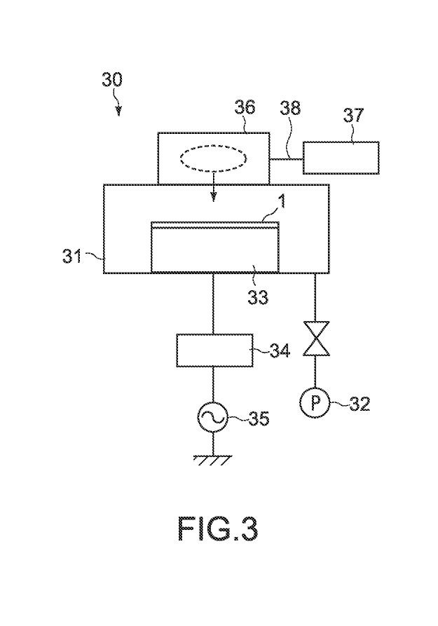

In the removal process of the resist mask 6, an ashing apparatus 30 having a configuration as shown in FIG. 3 is used.

The ashing apparatus 30 includes a vacuum chamber 31. The vacuum chamber 31 is connected to a vacuum pump 32 and can keep a predetermined reduced-pressure atmosphere in the inside thereof. Inside the vacuum chamber 31, a stage 33 for supporting the substrate 1 for which the etching process of the upper electrode layer 5 and the dielectric layer 4 has been completed is provided. The stage 33 is connected to a high frequency power supply 35 having a frequency of 13.56 MHz via a matching circuit 34, and predetermined bias power can be input to the stage 33.

The ashing apparatus 30 includes a plasma chamber 36 disposed on an upper portion of the vacuum chamber 11, the upper portion being opposed to the upper surface of the stage 33, an oscillator 37, and a waveguide 38. The oscillator 37 emits microwaves having a predetermined frequency (for example, 2.45 GHz). The waveguide 38 guides the microwaves emitted by the oscillator 37 to the plasma chamber 36 and excites ashing gas introduced into the plasma chamber 36. For the ashing gas, oxygen or mixed gas including oxygen is used.

The removal process of the resist mask 6 includes first treatment and second treatment. The first treatment is bombardment treatment of the resist mask 6 by using oxygen ions, and the second treatment is ashing treatment of the resist mask 6 by using oxygen radicals. The first treatment and the second treatment are performed with use of the common ashing apparatus 30.

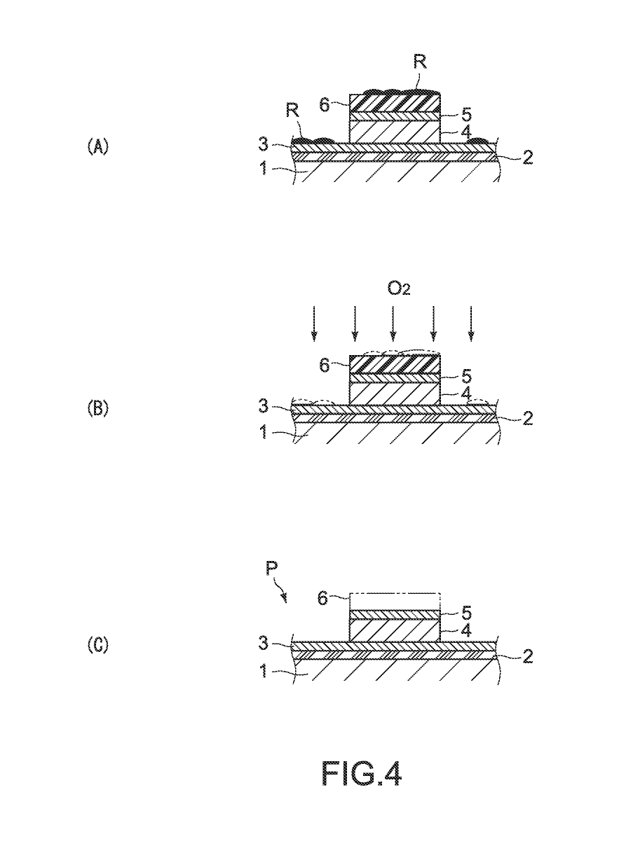

Reactants of chlorine gas or fluorocarbon gas that are generated when the upper electrode layer 5 and the dielectric layer 4 are etched are apt to be deposited on the surface of the substrate 1, because a vapor pressure is low. Therefore, as shown in FIG. 4(A), in the case where etching reactants R adhere to the surface of the resist mask 6, in the ashing treatment using oxygen radicals, the etching reactants R are not removed and remains as resist residue on the surface of the upper electrode layer 5. In this regard, in this embodiment, before the resist mask 6 containing oxygen radicals as main components is removed, the etching reactants R adhering to the surface of the resist mask 6 are removed by bombardment treatment using oxygen ions.

(First Treatment)

In the first treatment, oxygen gas is introduced into the vacuum chamber 31, high frequency power is applied to the stage 33 from the high frequency power supply 35. By a bias action of the high frequency power applied to the stage 33, the oxygen gas introduced into the vacuum chamber 31 is excited, and therefore a plasma is formed. Further, ions in the plasma (oxygen ions) are periodically drawn to the stage 33 and are caused to hit against the surface of the substrate 1. Thus, as shown in FIG. 4(B), the etching reactants R adhering to the surface of the resist mask 6 are physically removed.

Treatment conditions for the first treatment are not particularly limited. For example, a pressure is 27 Pa, an oxygen gas introduction amount is 200 sccm, bias power is 300 W, and a treatment time is 10 seconds. The bias power is set to be higher than that of the etching conditions described above, and therefore the etching reactants R can be efficiently removed. Further, the treatment time is shortened, and therefore etching of the lower electrode layer 3 by a sputtering action of the oxygen ions can be suppressed.

The oxygen gas may be introduced into the vacuum chamber 31 directly or introduced into the vacuum chamber 31 via the plasma chamber 36. Further, the plasma of the oxygen gas may be formed in the plasma chamber 36 by excitation of microwaves.

(Second Treatment)

Subsequently, the second treatment is performed. In the second treatment, mixed gas of oxygen and nitrogen is introduced into the plasma chamber 36 as ashing gas, and a plasma of the ashing gas is formed by microwaves emitted by the oscillator 37. High frequency power is not applied to the stage 33 within the vacuum chamber 31, Therefore, the substrate 1 is in a non-biased state.

The oxygen radicals in the plasma formed in the plasma chamber 36 flow into the vacuum chamber 31 along an exhaust flow formed by an exhaust action of the vacuum pump 32 (downflow). Thus, the resist mask 6 on the substrate 1 is exposed to the oxygen radicals and removed by a chemical reaction with the oxygen radicals (FIG. 4(C)).

Treatment conditions for the second treatment are not particularly limited. For example, a pressure is 276 Pa, a gas introduction amount is 9000 sccm of O₂ and 480 sccm of N₂, power of microwaves is 2000 W, and a treatment time is 120 seconds. During the treatment, the substrate 1 is put into the non-biased state, and therefore it is possible to control the ions in the plasma not to reach the substrate 1 and avoid a sputtering action of ions to the lower electrode layer 3. Further, the treatment time of the second treatment is set to be longer than the treatment time of the first treatment. Thus, a sufficient time can be secured for the removal of the resist mask 6.

As described above, the resist mask 6 is removed. In this embodiment, the etching reactants R adhering to the surface of the resist mask 6 are physically removed by the bombardment treatment using oxygen ions. Thus, the occurrence of resist residue due to the etching reactants R is suppressed, and the resist mask 6 is efficiently removed from the surface of the base material. Therefore, according to this embodiment, the dielectric device P (FIG. 1(E) and FIG. 4(C)) having desired characteristics can be stably manufactured,

Further, according to this embodiment, since the vacuum chamber 31 common to the first treatment and second treatment described above is used, the above-mentioned first treatment and second treatment can be successively performed. Thus, the increase in treatment time of the resist removal process can be suppressed.

Hereinabove, the embodiment of the present invention has been described, but the present invention is not limited to the above-mentioned embodiment and can be variously modified without departing from the gist of the present invention, as a matter of course.

For example, in the embodiment described above, the chlorine gas (Cl₂, BCl₃) is used for the etching of the upper electrode layer 5 and the dielectric layer 4. Instead of this, fluorocarbon gas (CF₄, C₃F₈, C₄F₈, CHF₃, and the like) may be used. Even the use of those gases causes a tendency that etching reactants adhere to the surface of the substrate. However, by the execution of the above-mentioned ashing method (first and second treatment), it is possible to remove the resist mask without generating residue.

The resistance random access memory element has been exemplified as a dielectric device. Though not limited thereto, the present invention is also applicable to a method of manufacturing any other dielectric devices such as a piezoelectric element, a ferroelectric memory element, and a capacitor, for which chlorine gas or fluorocarbon gas is used in etching of an upper electrode layer and a dielectric layer.

### DESCRIPTION OF SYMBOLS

1 substrate
2 insulating layer
3 lower electrode layer
4 dielectric layer
5 upper electrode layer
6 resist mask
10 dry etching apparatus
30 ashing apparatus
L laminated body
P dielectric device
R etching reactant

1. A method of manufacturing a dielectric device, comprising:
producing a laminated body in which a first electrode, a dielectric layer, and a second electrode layer are sequentially formed on a base material;
forming a resist mask on the second electrode layer, the resist mask being formed of an organic material;
sequentially etching the second electrode layer and the dielectric layer by a plasma of chlorine gas or fluorocarbon gas via the resist mask;
performing bombardment treatment on the resist mask by using oxygen ions; and
removing the resist mask by using oxygen radicals.

2. The method of manufacturing a dielectric device according to claim 1, wherein
the chlorine gas is gas containing BCl₃, and
the fluorocarbon gas is gas containing any one of CF₄, C₃F₈, C₄F₈, and CHF₃.

3. The method of manufacturing a dielectric device according to claim 1, wherein
the performing bombardment treatment on the resist mask includes introducing oxygen into the chamber and applying high frequency bias power to the base material.

4. The method of manufacturing a dielectric device according to claim 3, wherein
the removing the resist mask includes exposing the base material to oxygen radicals in an electrically non-biased state, the oxygen radicals being introduced into the chamber.

5. The method of manufacturing a dielectric device according to claim 1, wherein
the dielectric layer is a transition metal oxide layer.

6. An ashing method, comprising:
disposing a base material in a chamber, the base material having a surface etched by a plasma of chlorine gas or fluorocarbon gas via a resist mask formed of an organic material;
performing bombardment treatment on the resist mask by using oxygen ions in the chamber; and
removing the resist mask by using oxygen radicals in the chamber.
